(19) United States
(12) Patent Application Publication
(10) Pub. No.: US 2024/0086724 A1
(43) Pub. Date: Mar. 14, 2024

(54) RESTRICTIVE INHERITANCE-BASED RULE CONFLICT RESOLUTION

(71) Applicant: OptumSoft, Inc., Vero Beach, FL (US)

(72) Inventor: David R. Cheriton, Vero Beach, FL (US)

(21) Appl. No.: 18/243,631

(22) Filed: Sep. 7, 2023

Related U.S. Application Data
(60) Provisional application No. 63/405,817, filed on Sep. 12, 2022.

(51) Int. Cl. G06N 5/01

(52) U.S. Cl. CPC G06N 5/01

(57) ABSTRACT

A ruleset is structured to satisfy a restrictive inheritance requirement. A rule is selected from a set of matched rules with no successor, wherein the set of matched rules is a subset of the ruleset. A rule action associated with this selected rule is output. Input is received from a sensor. A physical actuator is controlled based at least in part on the input from the sensor and the rule action associated with this selected rule.

### CROSS REFERENCE TO OTHER APPLICATIONS

This application claims priority to U.S. Provisional Patent Application No. 63/405,817 entitled RESTRICTIVE INHERITANCE-BASED RULE CONFLICT RESOLUTION filed Sep. 12, 2022 which is incorporated herein by reference for all purposes.

### BACKGROUND OF THE INVENTION

Traditional rule-based systems may be limited in scope because the complexity of rule conflict during rule execution. It would be an improvement to apply rule-based systems to more substantial physical engineering by improving rule conflict to use less computing resource including less processing resource, less storage resource, and/or less network resource, and/or lower design times and/or lower runtimes for the rule-based system.

### BRIEF DESCRIPTION OF THE DRAWINGS

Various embodiments of the invention are disclosed in the following detailed description and the accompanying drawings.

FIG. 1 is a functional diagram illustrating a programmed computer/server system for efficient rule processing in accordance with some embodiments.

FIG. 2 is an illustration of the restrictive requirement.

FIG. 3 is an illustration of an example of a portion of a simple decision tree.

FIG. 4 is an illustration of an example of a partially derived rule.

FIGS. 5A and 5B are a flow diagram illustrating an embodiment of a process for generating fully-specified derived rules from partially-specified derived rules.

FIG. 6 is a flow diagram illustrating an embodiment of a process for determining whether to generate a leaf node and the rule action to use with a restrictive inheritance ruleset.

FIG. 7 is a flow diagram illustrating an embodiment of a process for resolving rule conflicts.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In a computer rule-based system, specified rules may lead to the rule conflict during rule execution. That is, the conditions of two or more rules are true and yet their actions are different. For example and without limitation, in an autonomous vehicle rule-based system such as an autonomous aircraft, if one rule indicates to increase the throttle and raise the elevators when below target altitude and another indicates to descend when an engine problem is detected, when both conditions occur, both rules “fire” yet the actions associated with the two rules are conflicting, that is contradictory.

Input for the rule-based system may be received from a sensor. A sensor as referred to herein is anything that detects, measures, and/or responds to a physical property and/or physical record. Examples of a sensor include without limitation: a camera, pressure sensor, speed sensor, fluid level sensor, load sensor, position sensor, torque sensor, center of gravity sensor, feedback sensor, airspeed sensor, vertical speed sensor, altimeter, cabin pressure sensor, temperature sensor, variable transformer sensors, force sensor, vibration sensor, magnetometer, gyroscope, data monitoring sensor, telemetry sensor, ultrasonic sensor, infrared sensor, speedometer, tachometer, tension sensor, microphone, a mechanical sensor, an electromagnetic sensor, an electronic sensor, a solid state sensor, an optical sensor, a company stock exchange (including a sensor to sense a stock price value), and/or a doctor's senses such as their eyes/nose/hands. In one embodiment, a rule relates the input from the sensor to a sensor data interpretation.

A physical actuator is controlled based at least in part on a rule in the rule-based system and input from one or more sensors. A physical actuator as referred to herein is anything that causes a physical device to (further) act, display, and/or operate. Examples of an actuator include without limitation: machine controls, aileron control, elevator control, stabilator control, rudder control, wing flaps control, leading edge devices, spoiler control, trim systems, autopilot toggle, ejection seat activator, accelerator, brake control, steering control, parking brake control, lights toggle, communications control, robot arms, LED display, database store, magnetic/optical storage, electromagnetic wave, stock purchase order, and/or a medical diagnosis record.

Traditionally, solutions to this problem teach the use of various rule conflict resolution approaches, including using priority, specificity, and even just executing the actions of both rules. However, it is difficult to provide trustworthy semantics to the resulting decision making with these approaches. For example, with 100 rules in a ruleset, there are potentially 2,100 rule combinations that could fire in any given rule evaluation with only 101 of these combinations corresponding to 1 or 0 rules being active. That is, there are many quadrillions of combinations of rules to consider unless there are known restrictions on the rule conditions that reduce these combinations. Therefore, it is generally infeasible to predetermine and specify the semantics of conflict resolution by these traditional techniques across this enormous number of combinations that can occur. Yet, in many applications, including the example of rule-based autonomous control of an aircraft, correct behavior under all conditions, and thus input value combinations, is imperative, for example to protect humans and/or property from injury.

An improvement is a restriction to require that there is no overlap between the rule conditions of any rule in the ruleset. As referred to herein, “overlap” is at least one input scenario or set of input values for which the conditions of two or more rules are true. This restriction requires the ability to test for overlap. For example, with 100 rules in a ruleset there are around 10,000 possible rule pairs to test and potentially an impractical number of input value combinations to try to detect an overlap between each pair, unless there is a faster way to determine overlap. Many practical application rulesets are substantially larger than 100 rules. Therefore, it is largely impractical to do this manually. However, with arbitrary rule conditions, overlap may be automatically detected by evaluating all the rule conditions on all possible input combinations, which is generally infeasible for a ruleset compiler or similar tool. An automatic means of testing for overlap is disclosed as an improvement.

An application ruleset is normally developed and evolved incrementally to expand the operating domain, adding new subconditions/features/inputs are part of this process. Continuing an example of an autonomous aircraft, the initial ruleset may only consider how to maintain flight and avoid obstacles, and not consider different forms of equipment failure. This initial ruleset may contain several hundred rules, if not more. To extend or evolve this ruleset to handle component failures means adding inputs or features that indicate the operational status of components.

Continuing an example of an autonomous aircraft, a rule “fires” when there is an engine fault and not otherwise requires adding an input indicating the fault status of the engine. The existing ruleset rules do not have this engine fault status as part of their rule condition. Therefore, without revision of these existing rules, their conditions may be true whether or not the engine fault status indicates a fault or not. Therefore, potentially every existing rule traditionally needs to be modified to take into account the engine fault status subcondition. Adding in a new subcondition to the rules, that of engine fault, and ensuring no overlap means revising every one of the existing rules to take this subcondition into account, including adding rules for when this condition is true. Otherwise, presumably a rule for engine fault that simply fired when the engine fault condition was true would match and overlap with all the other rules which do not take engine fault condition into account.

If, on the other hand, the traditional technique of priority is used, giving the engine fault rule higher priority, it could be that the aircraft immediately descends on an engine fault even though an existing rule would not have it descend because of other traffic just below it. That is, the priority-based solution can result in a mid-air collision. Another alternative, namely using specificity, the rule for reacting to obstacles in this particular case could be more specific, so would be chosen, effectively ignoring the engine fault status. However, a proper reaction in this case may be to just temporarily maintain current altitude before descending, rather than taking the action of either of the matching rules. Note that the correct rule to handle additional subconditions may differ in action from the existing rule with which it shares the same existing subconditions, that is the correct new rule overlaps and also conflicts because of the different action.

In practice, a ruleset may be extended with multiple new inputs or features. Continuing an example of an autonomous aircraft, when faults are added as a consideration to the ruleset, there are typically many fault conditions to consider, such as aileron seizing up, rudder malfunction, and so on; not just one. If there are K such fault conditions and they are independent, there are 2K possible combinations of fault conditions including no faults, so the fault conditions require potentially increasing the rules by a factor of 2K to avoid overlap. With realistic values of K, this may be a massive multiplier. One consequence is that the cost of developing and testing the rules with each such evolution becomes significantly greater. Therefore, strict enforcement of no-overlap may make the rule specification extremely expensive to develop and test when new features or inputs are added to the rule conditions, as may be needed. On each extension, the developer of such a traditional rules-based system may have to go back and modify almost all of the existing rules.

Many applications require a single action in response to an input scenario. Moreover, if it is known that there is a single rule action selected on each rule evaluation for a ruleset, traditional techniques show how to transform the ruleset into a decision tree, allowing far more efficient rule evaluation. In particular, the cost of rule evaluation is proportional to K, the number of inputs, not the number of rule conditions, which may be large. To illustrate with a simple example, if there are three inputs to the ruleset corresponding to airspeed, altitude and vertical speed and each of these inputs is mapped onto 5 different ranges in the ruleset, there can be up to (5*5*5)=125 rule conditions as combinations of these ranges, yet the decision tree is just 3 inputs deep, one level for each input. Therefore, it is an improvement in human safety, system reliability, and efficient computing resources to guarantee that a single rule action is selected each time, and this requires achieving no-overlap.

Another traditional alternative is to use so-called machine learning to automatically generate rules from labelled datasets. For example, using a labelled dataset of aircraft positions, rules could be automatically generated that identify likely mid-air collision situations. However, with this approach, the rules are only probabilistically correct and provide no guarantee that the right rule will fire to avoid a mid-air collision in all cases. Moreover, it is impractical to get realistic data for a large number of cases because mid-air collisions and near misses are rare. In general, probabilistic or heuristic rules are only applicable when the cost of being wrong is relatively low and machine learning is only appropriate to use when this is true and there are substantial labelled datasets available on which to train the system. That is not the case with autonomous aircraft and many other control systems, particularly for emergency and other less common scenarios.

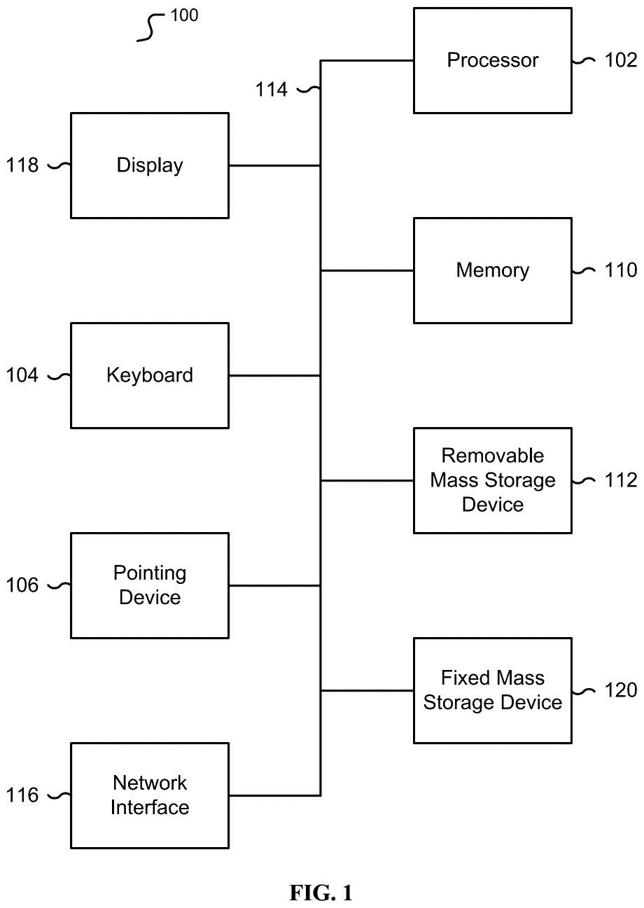

FIG. 1 is a functional diagram illustrating a programmed computer/server system for efficient rule processing in accordance with some embodiments. As shown, FIG. 1 provides a functional diagram of a general-purpose computer system programmed to provide efficient rule processing in accordance with some embodiments. As will be apparent, other computer system architectures and configurations can be used for efficient rule processing.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

Resolving Rule Conflicts Efficiently. An efficient yet semantically meaningful means of resolving rule conflicts to ensure correct operation of a rule-based system while efficient rule evaluation, such as provided by transformation to a decision tree is disclosed.

As referred to herein, a rule is simply a traditional “if . . . then”/conditional . . . action statement that is identified and may be manipulated by a compiler. Without limitation, it is not meant herein to imply or require or exclude the rules being executed by a rule execution engine as may be done traditionally.

Rules are contained in a partially ordered ruleset with a restrictive requirement. As used herein, partial order is used in the conventional mathematical sense in that each rule has a rule “before” it or less than it, its predecessor, except one, the “first” one, and, if rule R1 is less than R2 and R2 is less than R3, then R1 is less than R3 (transitive), and if R1 is less than R2 then R2 cannot be less than R1. The term successor of Ri is used herein to mean a rule Rj that is greater than a rule Ri in this partial ordering. (It is referred to as a “partial” because there may be a rule Ri which is neither less than or greater than Rj, for some pair of rules Ri and Rj). The restrictive requirement is defined and referred to herein:
1. There is a default or first rule that is an (indirect) predecessor in this partial order to all rules in the ruleset;
2. Each successor rule Rj to a rule Ri in the ruleset must match (at most) a subset of the input scenarios that the rule condition for Ri matches; and
3. There is no overlap between the input scenarios matched by one successor rule Rj to Ri and another successor Rk to Ri.

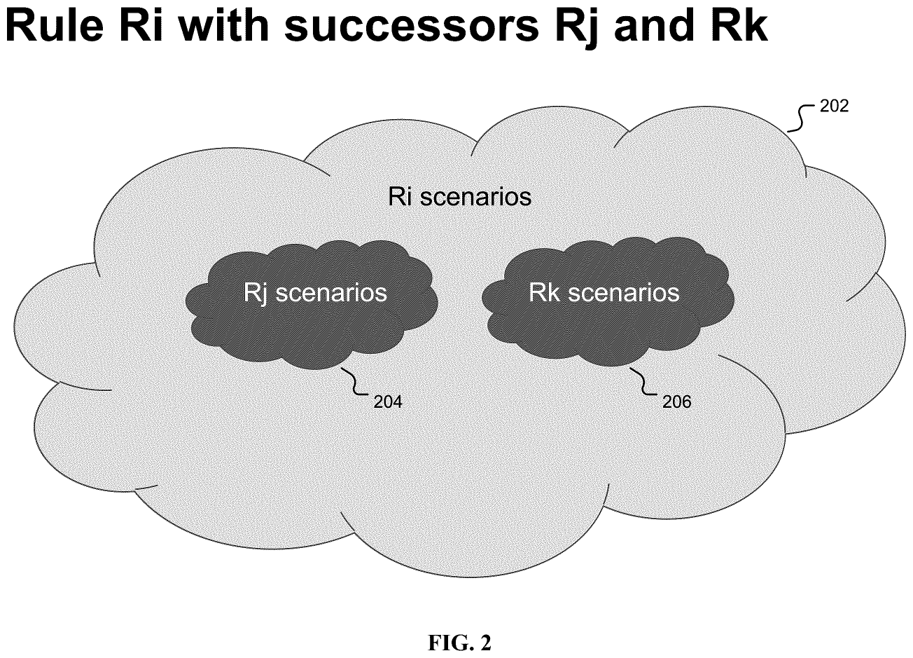

FIG. 2 is an illustration of the restrictive requirement. As shown in FIG. 2, scenarios matched by Rj (204) and Rk (206) are a subset of those matched by Ri (202) and the scenarios matched by Rj (204) do not intersect with the scenarios matched by Rk (206). As shown in FIG. 1, Ri (202) is the default/first rule. Another alternative is that Ri's input scenarios are contained in the set of input scenarios handled by another first rule Ro, which is not shown in FIG. 1, wherein scenarios matched by Ri (202) are a subset of those matched by Ro. A ruleset meeting the restrictive requirements is referred to herein as a restrictive inheritance ruleset.

Informally, FIG. 2 may be thought of as a simple hierarchy where a rule-based system designer defines what to do in the Ri (202) case, and a designer notes a subcase exception Rj (204) where the corresponding action is something different than for the main case Ri (202). A designer may also note a second subcase exception Rk (206) where the corresponding action is something different than for the main case Ri (202), which may be the same action or a different same action than that specified by Rj (204). As shown in FIG. 2, Rj (204) and Rk (206) do not overlap given the restrictive requirement.

A ruleset compiler may check and enforce these requirements on rules providing it can compare the set of input scenarios matched by one rule condition versus another. In one embodiment, each rule condition is evaluated on each possible combination of input values (that is, input scenario) to see when both rule conditions evaluate to true.

It would be a violation of the restrictive requirement, if Rj or Rk matches scenarios outside of the domain that Ri matches. It would also be a violation of the restrictive requirement if there was an input scenario that matched both Rj and Rk.

In evaluating an input scenario with a restrictive inheritance ruleset, when multiple rule conditions are matched, the conflict resolution selects the one rule Rj that has no successor in this match set as the one to act upon. As referred to herein, Rj overrides its predecessors and conversely, its predecessor rules are overridden by Rj.

This approach results in exactly one rule being selected in a restrictive inheritance ruleset. This is because multiple rules Ri and Rj can only be matched with the same input scenario if Rj is later in the partial order than Ri, or vice versa. Moreover, no rule Rk can be selected that is not partially ordered relative to Rj because it cannot overlap with the scenarios matched by Rj, by the restrictive requirement parts (1) and (3) as stated above. Part (1) ensures that any two rules in the ruleset have at least one common predecessor, namely this first or default rule. It also ensures that at least one rule has its rule condition matched on each input combination, namely this default rule.

Using a restrictive inheritance ruleset differs from traditional rule conflict resolution. The priority-based approach imposes a total ordering on rules and imposes no requirements on the rule conditions between rules. The specificity approach simply requires selecting the rule with the rule condition with the most attributes of those matched, which is not necessarily the one that matches with a strict subset of another matched rule. The random selection or “most recent” selection approaches use completely different criteria.

Again, in practice an overriding rule may arise as a result of refining an existing ruleset with additional conditions. For example, consider again a ruleset for controlling an autonomous aircraft that does not initially consider engine failure. The rules added to handle engine failure, qualified on other relevant conditions, overlap with previous rules that are not qualified by the fault status of the aircraft. Therefore, a new rule that is qualified by the fault status overlaps with existing rules that do not. To meet the restrictive inheritance requirements, a new rule needs to have a rule condition that matches a subset of the input scenarios of an existing rule and it needs to include the fault status. Because the existing rule does not include the fault status, the new rule necessarily then matches on a subset of the input scenarios matched by the existing rule, namely that subset where an engine fault is indicated. By relying on restrictive inheritance conflict resolution, it is not necessary to modify the existing rules as part of adding rules to handle fault conditions. The new rules simply “override” the existing rules in the cases in which their rule condition is true.

In one embodiment, the first or default rule is specified with a rule condition that matches all input scenarios and a rule action that corresponds a default action, such as “handle being outside operating domain.” With this rule condition, it clearly matches on a superset of scenarios for any possible rule, so it is a predecessor to all possible rules. The default action is taken to handle any input scenario that no other rule in the ruleset matches.

Restrictively Derived Rulesets. In one embodiment, a ruleset DRS can be specified as restrictively derived (as referred to herein) from a base restrictive inheritance ruleset BRS, thereby including in DRS all the rules in BRS. In this case, a rule DRm is referred to herein as being derived from a rule BRj in ruleset BRS if input scenarios that DRm matches on are a subset of those matched by BRj. If the derived ruleset adds additional features or subconditions to consider, the base rules are interpreted as implicitly specifying “don't care” for these additional subconditions. This derivation is referred to herein as restrictive inheritance. Restrictive inheritance requires that each rule in DRS derives from a rule in BRS and there is no overlap between two rules in DRS that derive from a common base rule. The ruleset compiler may automatically check that the restrictive inheritance requirements are met between the specified base ruleset and the derived ruleset.

With restrictive inheritance, assuming BRS is a restrictive inheritance ruleset, DRS is also a restrictive inheritance ruleset. This is because for any two rules R1 and R2, if they are derived from different base rules, they cannot overlap because their respective base rules do not and their matching domain is contained in that of their respective base domains. If they are derived from a common base rule, they cannot overlap based on the fundamental restriction on overlap. Therefore, the restrictive inheritance rule conflict resolution can be applied to DRS as well.

Restrictive inheritance between rulesets allows an application-level ruleset to be incrementally developed from a base ruleset without having to go back and revise existing rules, for example in the base ruleset. Instead, derived rules are introduced that simply override an existing rule in the special cases that are required. For example, using the earlier example of an autonomous aircraft, the rule for acting on being below the target altitude and there being an engine fault is a derived rule of the base rule for being below the target altitude. Note that there may be separate rules for the aircraft being at or above the target altitude. The base rule subconditions provide the requisite conditions about the aircraft and the vicinity; the derived rule adds in the engine fault subcondition in combination with the subconditions of the base rule.

The restrictive inheritance facilitates developing, maintaining and evolving application rulesets while ensuring single predictable action is taken on each input. It also allows efficient rule evaluation by being convertible to a decision tree, as described below. This restrictive ruleset inheritance is similar to the use of inheritance in object-oriented programming (“OOP”) in the sense that a derived type builds on an existing base type without directly modifying this existing base type. However, it differs in that a derived rule is restricted to applying only to a subset of the input scenarios that the base rule applies to. Note that by contrast with conventional/unrestricted OOP inheritance, a derived type can override a restriction in the base type to allow for instances that are more general than the derived type.

Note that it is necessary for the derived rule to effectively inherit the subconditions (or a restricted version of same) of the base rule in order to be restricted to a subset of the scenarios that the base rule matches, as required by the above definition of restrictive inheritance. Stated the other way around, the derived rule overrides its base rule when the derived rule condition or conditions are true. In this sense, the derived rule specializes the action of the base rule in the case that the derived rule condition is true. Note that this specialized action may be completely different from that of the base rule.

Given the requirement for a default rule from which all rules derive, any restrictive inheritance ruleset may be realized as a restrictively derived ruleset from the base ruleset that contains just the default rule for the associated subconditions or attributes, as the traditional methods refer to them. This construct justifies the term restrictive inheritance ruleset; that is, a single rule ruleset with simply the default rule is a restrictive inheritance ruleset. Moreover, any restrictive inheritance ruleset may be realized as a restrictive inheritance structure from this single ruleset. There may also be multiple levels of (restrictive) inheritance between the default rule and the ultimate application-level ruleset. Note that a base ruleset may have multiple derived rulesets, each a separate ruleset.

In one embodiment, a rule may specify as its decision action, an array of parameters values that are to be used. For instance, the array values may specify a target range for the throttle, elevators, ailerons, etc. In this example, the action of the derived rule may be the result of combining the parameter value array of the base rule with that of the derived rule. Returning to the earlier example, flying below target altitude and deriving in engine failure, the engine failure parameters can significantly restrict the control parameters associated with climbing so the combined result with traffic below is to just maintain the current altitude while this traffic is present. This is essentially an intersection of the ranges of the corresponding parameters between the two action arrays of values. The ruleset compiler may support other methods of combining rule actions to produce the actual action of a derived rule.

Note that the subconditions of the base rule may be included by reference to reduce the duplication in the ruleset, especially if the final result is a decision tree, given the decision tree may make rule evaluation more efficient. For instance, a partially-specified derived rule may contain a list of the base rules from which it is restrictively inherits, as determined by the ruleset compiler. In one embodiment, such a partially-specified derived rule specifies one or more of its base rules explicitly, rather than only being matched to base rules based on overlap, and is referred to herein, as an explicit-specified base rule. An explicit-specified base rule may also be a partially-specified derived rule.

A decision tree can be generated for a restrictive inheritance ruleset by:
1. generating a decision tree for the base rules; that is, those with no base or a default base rule; and
2. for each leaf of the base tree, generating a decision subtree for the derived rules of the base rule that corresponds to the leaf.
   That is, an overlapping rule is in the decision subtree of the decision subtree handling the rule with which it overlaps, or vice versa.

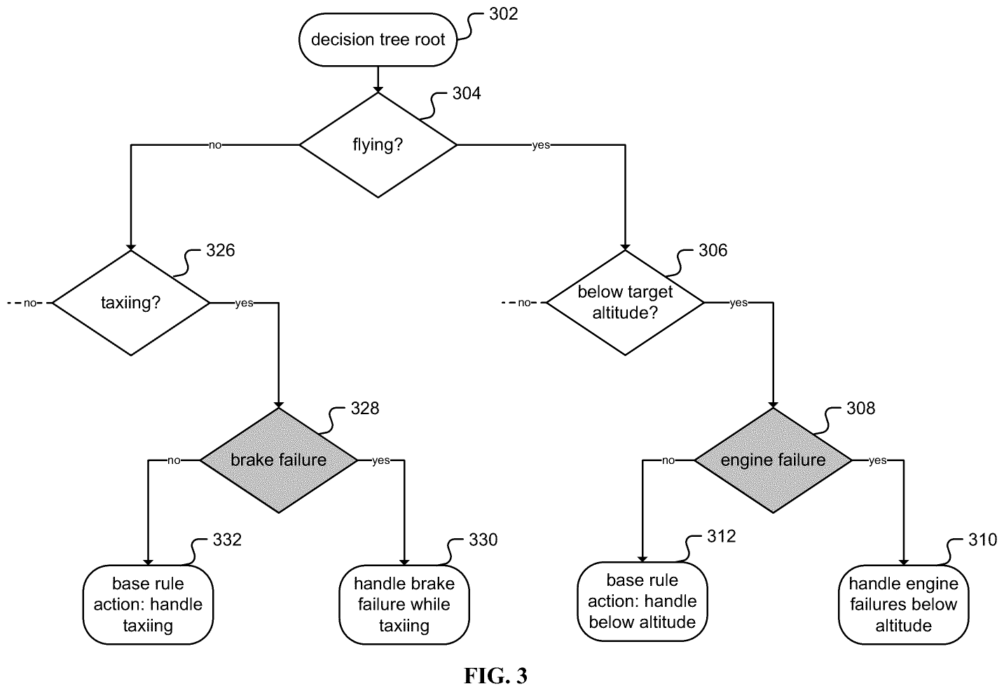

FIG. 3 is an illustration of an example of a portion of a simple decision tree. In FIG. 3, the root decision node (302) decides whether the aircraft is flying or not (304). If the aircraft is flying it selects whether it is below the target altitude or not (306); this is a base rule. The shaded decision node for engine failure (308) overrides this base rule in the case of engine failure when it is present (310) and otherwise uses the base rule action (312). If the aircraft is not flying it selects whether it is taxiing or not (326); this is a second base rule. The shaded decision node for brake failure (328) overrides this second base rule in case of brake failure when it is present (330) and otherwise uses the second base rule action (332).

Because the derived rule for handling engine failure is required to follow restrictive inheritance, the derived rule has a rule condition that is a further restriction on the base rule. The further restriction in this case is that requiring engine failure. Therefore, its additional condition, engine failure, may be appended to the leaf node of the base decision tree. If the derived rule also restricted other conditions such as the degree it was below target altitude, there would be, in the derived decision subtree, a further decision node testing the degree it is below target altitude. The case of a derived rule handing brake failure while taxiing (330) is similar, only being relevant in the subtree that indicates the aircraft is taxiing, and only overriding the base rule action (332) when a brake failure is occurring.

This construction demonstrates that a decision tree may be generated for a ruleset that obeys the restrictive inheritance requirement, that is, in which there are base rules that do not overlap with each other and each derived rule restrictively inherits from one of the base rules. It does not preclude generating the decision tree using one of the efficient traditional methods from such a ruleset.

Partially-Specified Derived Ruleset. In one embodiment, one or more rules in the derived ruleset may be specified as partially-specified derived rules. A partially-specified derived rule as referred to herein is a derived rule whose condition only specifies the differences between a base rule or the base ruleset and that desired as the end result derived rule or ruleset, as opposed to the entire rule condition and action. In the former case, it may specify the base rule(s) explicitly as indicated above in the mention of an explicit-specified base rule. Alternatively, a partially-specified derived rule may be derived from each base rule with which it overlaps, as described below. (The former case may be regarded as specifying the overlap in part as defined by the rule condition in each specified base rule.)

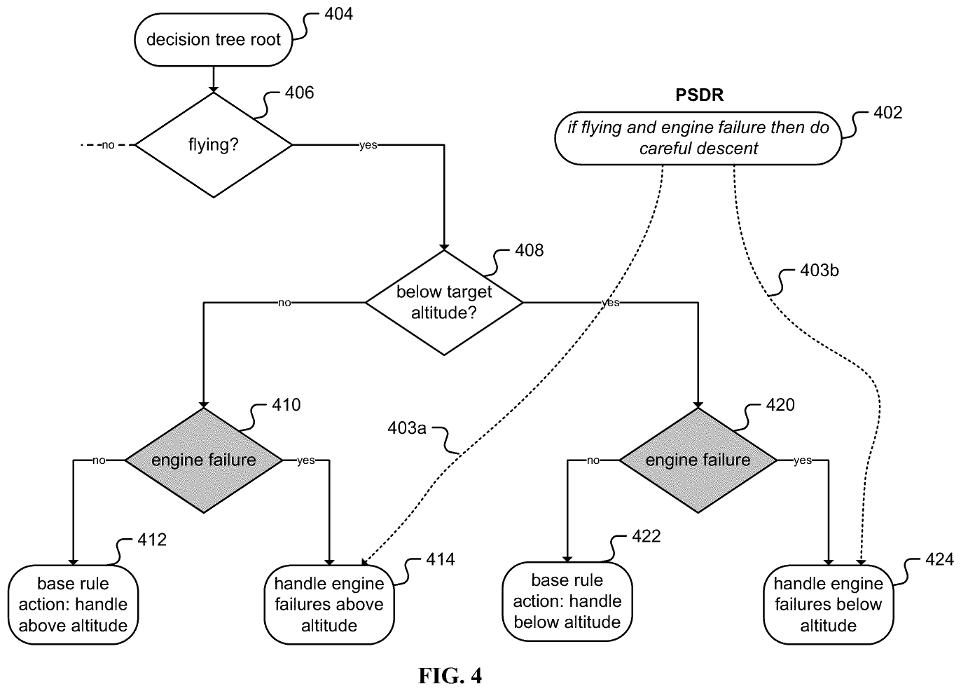

FIG. 4 is an illustration of an example of a partially derived rule. In FIG. 4, the partially derived rule specifies the rule (402):
if flying and engine fault,
   then do a careful descent
      In FIG. 4, the root decision node (404) decides whether the aircraft is flying or not (406). If the aircraft is flying it selects whether it is below the target altitude or not (406). When the aircraft is not flying below target altitude, the shaded decision node for engine failure (410) overrides this base rule in the case of engine failure when it is present (414) and otherwise uses the base rule action (412). When the aircraft is flying below target altitude, the shaded decision node for engine failure (420) overrides this base rule in the case of engine failure when it is present (424) and otherwise uses the base rule action (422).

The rule (402) is partially-specified, as referred to herein, because it does not indicate the required value of the aircraft altitude relative to the target altitude. As described above and without limitation, a partially-specified derived rule may either explicitly specify its base rules or have its base rules determined by overlap. This partially-specified rule has a condition that overlaps with two base rules in this example, namely: (1) that for flying below the target altitude, and (2) that for flying at or above target altitude. Therefore, the ruleset compiler creates two derived rules, one for each of these base rules as indicated by the dashed arrows (403a), (403b) in the figure. Thus, it produces in this example, a fully-specified derived rule that corresponds to the condition corresponding to: flying, below target altitude and engine fault (414) as well as a fully-specified derived rule that corresponds to the condition flying, above target altitude and engine fault (424).

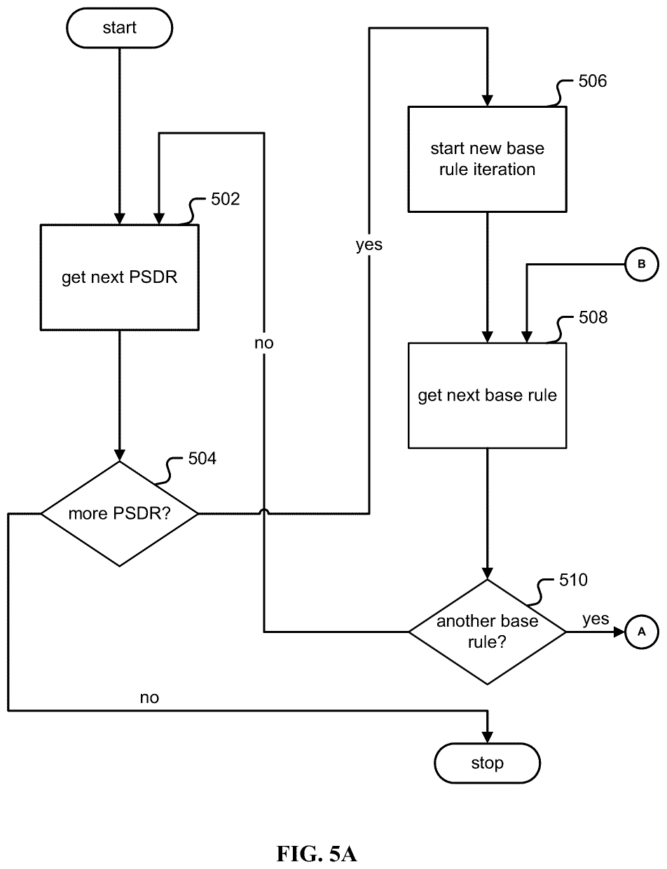

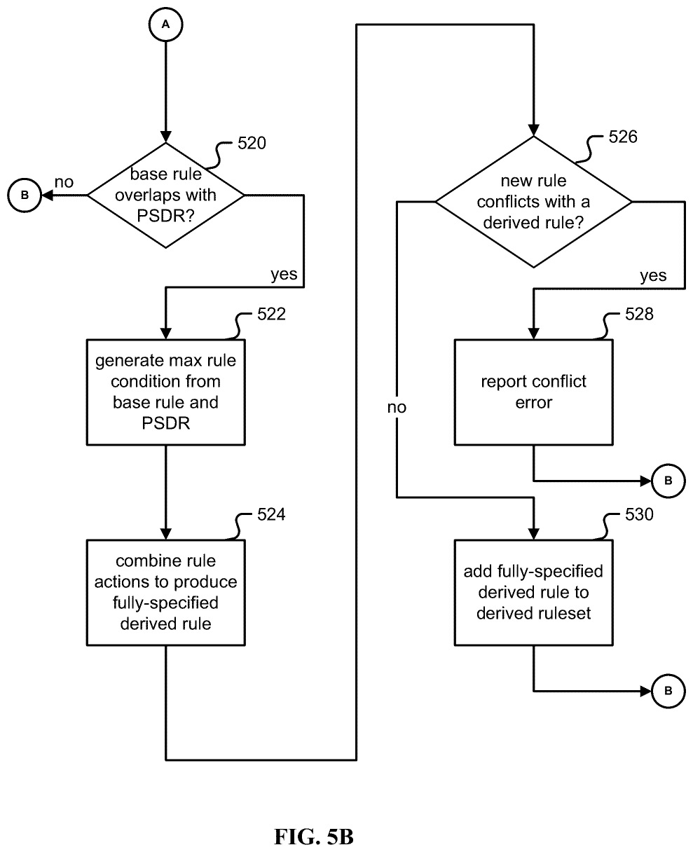

FIGS. 5A and 5B are a flow diagram illustrating an embodiment of a process for generating fully-specified derived rules from partially-specified derived rules. In one embodiment, the process of FIGS. 5A and 5B is carried out by the system of FIG. 1 and/or a ruleset compiler.

As shown in FIGS. 5A and 5B, the process includes an iteration over partially-specified derived rule set, and a nested iteration over the base rule set plus a test for overlapping in associated rule conditions, in part for each pair of partially-specified derived rule set and base rule set whose rule conditions overlap to generate a suitable derived rule, which is added to the set of derived rules unless this generated rule conflicts with another derived rule, in which case, there is a conflict is reported instead.

In step (502), the next partially-specified derived rule is selected from the derived ruleset and labeled PSDR. Following the earlier example, a partially-specified derived rule may be:
PSDR: if flying and engine fault,
   then do a careful descent

In step (504), in the event there are no more PSDR control is stopped and the process complete; otherwise the rules in the base ruleset are iterated over in step (506). In part, for each rule in the base ruleset that overlaps with the rule condition of PSDR as determined in step (520), the process gets the next base rule in step (508) and generates a derived rule condition that has the maximum coverage of scenarios that fits the condition consistent with restrictive inheritance as shown in step (522). For example, if the base rule is:
if flying and attitude greater than 1000 feet and traffic below,
   then increase altitude
      the rule condition for the fully-specified derived rule would be
if flying and attitude greater than 1000 feet and traffic below and engine fault,
   then maintain altitude
      That is, the subcondition of “greater than 1000 feet” is added from the base rule and the subcondition “engine fault” is added from the derived (partially-specified) rule. Note that there could be a separate base rule for flying below 1000 feet and traffic below. In that case, a separate iteration in the process of FIGS. 5A/5B would combine PSDR with this separate base rule to produce:
if flying and attitude less than 1000 feet and traffic below and engine fault,
   then {corresponding action}

In both of these cases, as shown in step (524) the action for the generated fully-specified derived rule is produced from a combination of the actions of PSDR and the current base rule. For example, with the first case, the base rule action is to climb and the derived rule action is to descend. The combination as an intersection results in the action to simply maintain altitude. On the other hand, if the base rule does not overlap with PSDR in step (520), control is transferred via node (B) to step (508) to get the next base rule.

As a final step in the iteration started in step (506), the ruleset compiler checks to see if the generated derived rule overlaps in step (526) with any of the other fully-specified derived rules in the derived ruleset. If so, the process indicates an error in step (528) and control is transferred via node (B) to step (508) to get the next base rule. Otherwise, this generated derived rule is added to the derived ruleset in step (530). Control then continues the processing with the next base rule in the base ruleset via node (B) to step (508). If there are no more base rules to consider for PSDR in step (510), it selects the next partially-specified derived rule in the derived ruleset if available in step (502) and repeats the iteration over the base rules starting in step (504) as described above. If there are more base rules to consider for PSDR in step (510), control is transferred via node (A) to step (520) as described above.

In one embodiment, a derived rule specifies a combination method to be used to combine its action with that of each base rule. The specific combination methods may include:
1. intersect—takes the intersection of parameter values between the two rules;
2. override—use the derived parameter values for any values that differ from the base rule action;
3. union—effectively take both actions; and/or
4. library—look up the combined action in a library Other action combination methods may be supported.

On the library method described above, in one embodiment the action or decision rule of an actual derived rule, generated from a specified derived rule, is generated from the combination of the action of the base rule and that of the derived partial rule. For example, with an autonomous aircraft, the derived partial rule for left engine fault combined with the “slow climb” rule produces a rule with the action labelled “slowClimb+leftEngine fault.” The application may then map this rule action name to the appropriate actual action or select a default action, possibly using so-called “wildcard” matching of names. For example, with K different possible faults, a developer may define roughly K-squared rules corresponding to there being two or more faults occurring at the same time and have each map to a default best-efforts action. Then, if the fault handling is defined as the partial ruleset union of component partial rulesets, as described in U.S. patent application Ser. No. 18/225,627 entitled AUTOMATIC GENERATION OF RULES AND CONTROL FROM PARTIAL RULESETS filed Jul. 24, 2023 which is incorporated herein by reference for all purposes, one for each component, all the combinations of two or more faults are mapped to this best-efforts action. The developer then may only need to specify rule actions for individual faults in combination with the base rules. This is an improvement in processing because the number of independent fault combinations may be very large, as suggested earlier.

In general, the ruleset compiler instantiates a fully-specified derived rule for each base rule that overlaps with the rule condition of the derived rule. In the extreme, it is possible in a realistic version of this example for a partially-specified derived rule such as the engine fault rule to overlap every rule in the basic flight operations base ruleset because an engine fault can occur in any situation. As in the earlier example, a derived ruleset can incorporate the environmental factors by adding in subconditions that characterize the external conditions such as other traffic, weather conditions, etc and the associated rules and actions.

With partially-specified rules in a derived ruleset, the developer of the derived ruleset may only have to specify the additional subconditions or any restrictions on original subconditions and the associated action and the action combination method. The ruleset compiler may handle the actual generation of, and checking of, the rules as well as the automatic transformation into a decision tree representation. The ruleset compiler may do the latter by resolving the rule conflict between the base and derived rule by selecting the most derived rule when under the conditions that it applies. In this way, with restrictive inheritance, there is at most one rule action for a given input value combination and therefore, a decision tree may be generated to provide efficient rule evaluation.

In one embodiment, a derived ruleset, possibly including partially-specified derived rules, is generated by a ruleset operator, using the methods disclosed in U.S. patent application Ser. No. 18/225,627. For example, the partially-specified derived ruleset that introduces the handling of equipment faults may be generated as the union of a plurality of partial rulesets, one for each different powerplant and control surface on the aircraft. The ruleset compiler then generates fully-specified derived rules from these partially-specified derived rules and the base rules, using the above-described method.

A partially-specified derived rule and its handling relative to a base rule is analogous to a derived class in a conventional object-oriented programming language such as C++. In particular, a C++ derived class only specifies the differences between the intended actual derived class and the specified base class. That is, the derived class does not repeat the member functions and data members of the base class but includes them by reference to the base class, and they are logically and actually part of the derived class at execution time. Moreover, the derived class can specify one or more member functions that are also present in the base class to override those base member functions, similar to the overriding that occurs with a partially-specified derived rule. However, with C++, there is a single, explicitly specified base class whereas a partially-specified derived rule is effectively and implicitly derived from every base rule in the base ruleset with which it overlaps, and the rule condition and rule action generation for the actual derived rule is more complex.

Ruleset Compiler Support. A ruleset compiler may be used to automatically read, check, and optionally convert a restrictive inheritance ruleset into a decision tree. In one embodiment, the compiler may automatically infer that a rule DR is derived from a base rule BR based on its overlap with base rules, that is, DR is a successor in the partial order to BR. That is, rather than the derived rule DR explicitly specifying its predecessor, the compiler may determine the base rule or rules whose rule condition corresponds to a superset of the scenarios that the current rule DR matches. For example, referring back to FIG. 3, the ruleset compiler may determine that the derived rule whose condition specifies flying, below target altitude and engine failure overlaps with the base rule of flying and below target altitude and thereby infer (restrictive) inheritance, automatically identifying the base rule as the base rule of this particular derived rule. Thus, the determination of which are the base rules and the checking of the derived rules against these base rules may be performed automatically by the ruleset compiler. The ruleset compiler may report an error if a rule overlaps with two different base rules when one is not a derived rule of the other. For instance, a rule that specifies a rule condition of flying above or below the target altitude and aileron seize-up would overlap the base rule for flying above the target altitude and the separate base rule for flying below the target altitude.

Note that if the derived rule DR is a subset of some base rule, it cannot be a derived rule of another base rule because the base rule is assumed and required to not overlap any other rule in the base ruleset. Therefore, it is sufficient for the ruleset compiler to simply verify that there is no overlap between the rules in the derived ruleset besides determining a base rule.

To illustrate with an example of an autonomous aircraft, a first-level base ruleset may handle flight operations without consideration of external concerns such as altitude, weather and other traffic. A ruleset compiler may verify that this base ruleset does not contain any overlapping rules. A derived ruleset may then be developed that includes additional features and inputs, including subconditions, for the external concerns and rules that override base rule behavior based on these additional subconditions. The ruleset compiler may then verify that each rule in the derived ruleset of this base ruleset restrictively inherits from a rule in the base ruleset and does not overlap with another rule in the derived ruleset with the same base rule. Therefore, the compiler may verify that the derived ruleset produces a single rule action on every input value combination by just examining the overlap between rules in the derived ruleset and between the derived rules and the rules in the base ruleset, assuming the restrictive inheritance property of the base ruleset.

The ruleset compiler may use various techniques to determine overlap between rule conditions. For one, it may exhaustively evaluate the rule conditions using all possible input values. In some cases, it may be feasible to analyze the rule conditions to reduce the number of input values to consider. It is an improvement to restrict the form of rule conditions to reduce the compile-time evaluation. A particular restrictive form is described below.

In one embodiment, one or more subconditions are specified as a range or ranges for the given decision value. For example, the “low altitude” subcondition may be specified as an altitude between 5 feet and 400 feet. With these subconditions, it is more efficient in terms of computing resources for the compiler to automatically determine if a given subcondition in a rule R1 overlaps with the corresponding subcondition in another rule R2. Continuing the above example, if the first uses the low altitude subcondition as defined above, and the second uses the reduced range of 5 feet to 100 feet, the latter subcondition is noted to overlap (and is contained in) the first altitude range.

In one embodiment, a rule condition is specified as the conjunction of identified subconditions, each specified as a range as above. In this case, it is straight-forward for the compiler to detect overlap and subsetting between rule conditions as well as generate revised rule subconditions. For example, if the engine fault partial derived rule specifies the range of altitude between 5 feet and 40000 feet, and the base flying rules specify different actions between 5 feet and 400 feet versus 400 to 40000 feet, the ruleset compiler may split the derived rule into one for 5 feet to 400 feet and one from 400 feet to 40000 feet in order to maintain the subset requirement for actual derived rules.

Method to Select an Action in Generating a Decision Tree. A technique such as that described in “RBDT-1: a New Rule-based Decision Tree Generation Technique” by Amany Abdelhalim, Issa Traore, and Bassam Sayed may generate a decision tree from rules. There, a decision tree leaf node is generated when the subset of rules for the current subtree all result in the same rule action and is an error when there are two or more rules with different actions remaining in this subset when all the subconditions of the rule conditions have been evaluated. However, with a restrictive inheritance ruleset, it is possible to have a plurality of rules with different actions at this point. Therefore, these traditional methods may be improved/modified/extended to handle the restrictive inheritance rulesets described herein.

Traditional techniques, including that referenced above, recursively construct the decision tree by selecting a subcondition or attribute for the next decision node of a decision subtree and then partitioning the rules associated with the decision path to that node based on the values of that subcondition, recursively generating a decision subtree for each partition of the rules. The path in the decision tree from the root to the current decision node represents a partial rule condition corresponding to the conjunction of the subconditions of each decision node on the path. For example, in FIG. 4, the “engine failure” node (420) corresponds to the partial rule condition “flying and below target altitude.”

Normally, a leaf decision node is generated when there is a single rule in the partition or when all the rules in the partition designate the same action. However, with restrictive inheritance, a partition logically contains all the base rules of any rule in the partition and these base rules normally have different associated actions.

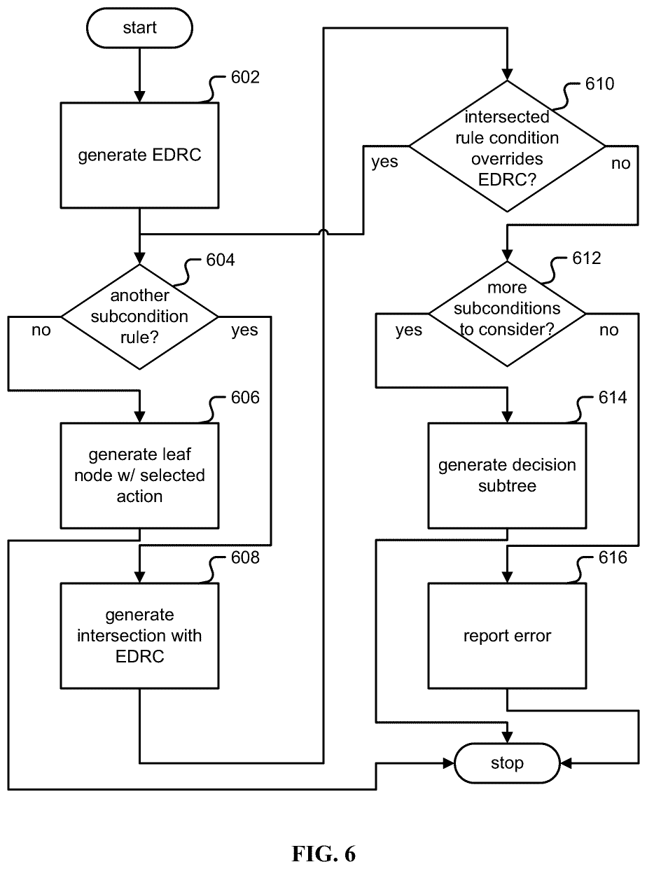

FIG. 6 is a flow diagram illustrating an embodiment of a process for determining whether to generate a leaf node and the rule action to use with a restrictive inheritance ruleset. In one embodiment, the process of FIG. 6 is carried out by the system of FIG. 1 and/or a ruleset compiler.

When a new subtree of the decision tree is to be generated, there is a partition or subcollection of rules SCR, such that each of these rules has a rule condition that could be true, given the path to this root node of this subtree. Before a next subcondition/attribute is selected, with a restrictive inheritance ruleset, the following process is executed to determine if a leaf node can be generated at this point instead:
1) In step (602), generate the effective default rule condition (EDRC) for this node, namely the partial rule condition corresponding to the path to this decision node, with the default action.
2) As shown in the loop starting with step (604), for each rule R in this subcollection SCR:
   a) In step (608) generate the intersection of rule R with the effective default rule condition;
   b) In step (610) check that the rule condition produced by this intersection overrides the effective base rule condition or has the same action as the effective base rule condition;
   c) if in step (610) it does not, indicate a conflict with this being leaf node partition and exit the iteration with control being transferred to step (612); and
   d) otherwise record the rule action for this rule as the potential action for this leaf if it has no successor in SCR and control is transferred to step (604) for the next rule in subcollection SCR.
3) if no conflict was detected and there are no more rules in step (604), control is transferred to step (606) to generate a leaf node with the recorded potential rule action PRA as the rule action for the leaf node.
4) if a conflict was detected in step (612) and there are more subconditions to consider, the process generates a subtree for the rules in SCR as per traditional techniques in step (614).

If there is a conflict in step (612) yet there are no further attributes or subconditions on which to differentiate the conflicting rules, it is not feasible to complete the decision tree and an error is indicated as shown in step (616).

Note that the effective default rule condition is a base rule condition for all rules in SCR. Therefore, if there are two rules R1 and R2 in SCR, either R1 is a base rule for R2 or vice versa. Otherwise, if both R1 and R2 override the effective default rule condition, they overlap on this rule condition and yet do not have an inheritance relation, contradicting the restrictive inheritance requirement.

Note that this method does not preclude generating unnecessary subtrees when the rules in a partition are not inheritance-related yet have the same action. However, note further this duplication is not specifically related to restrictive inheritance.

As disclosed, what is otherwise a run-time rule conflict traditionally is resolved at “compile-time”, that is the time of generating the decision tree by recognizing when a rule overrides another to resolve the conflict. This provides a computing resource improvement that the rule conflict resolution overhead is eliminated from rule evaluation.

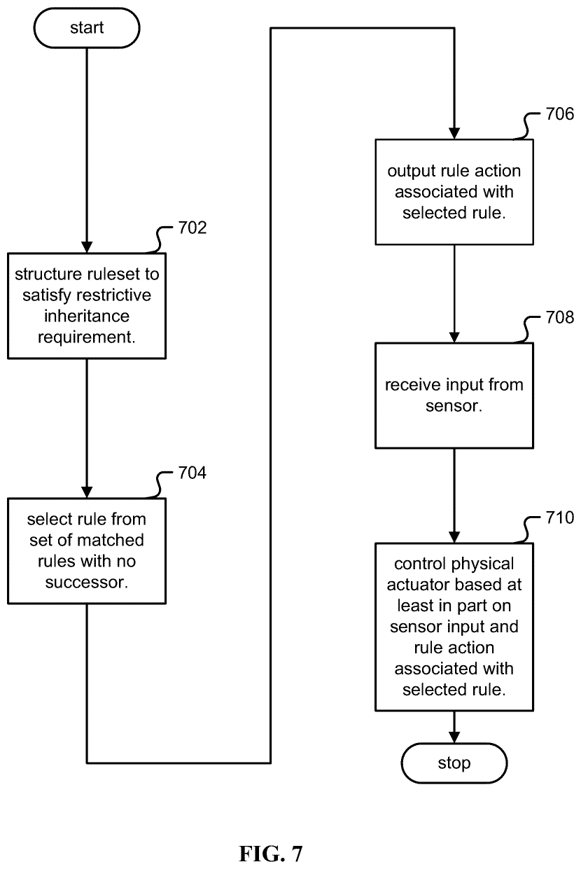

FIG. 7 is a flow diagram illustrating an embodiment of a process for resolving rule conflicts. In one embodiment, the process of FIG. 7 is carried out by the system of FIG. 1 and/or a ruleset compiler.

In step (702), a ruleset is structured to satisfy a restrictive inheritance requirement. In one embodiment, this step may happen at compile-time. In one embodiment, this step may happen at run-time. In one embodiment, restrictive inheritance is realized in part by deriving the ruleset restrictively from a base ruleset that is a restrictive inheritance ruleset. In one embodiment, one or more derived rules are partially-specified and materialized using partially-specified restrictive inheritance. In one embodiment, a rule condition is specified as a conjunction of subconditions. In one embodiment, one or more subconditions are indicated as a range of values.

In step (704), a rule is selected from a set of matched rules with no successor, wherein the set of matched rules is a subset of the ruleset. In one embodiment, this step may happen at compile-time. In one embodiment, this step may happen at run-time.

In one embodiment, selecting the rule from the set of matched rules with no successor is based at least in part on rule evaluation. In one embodiment, selecting the rule from the set of matched rules with no successor is based at least in part on decision tree generation. In one embodiment, decision tree generation avoids multi-matches by selecting the most derived rule when two or more rules are applicable to an input.

In step (706), a rule action associated with this selected rule is output. In one embodiment, the outputted rule action is a combination of rule actions of a base rule and a derived rule, wherein the base rule is a rule from the base ruleset.

In step (708) input is received from a sensor. In step (710), a physical actuator is controlled based at least in part on the input from the sensor and the rule action associated with this selected rule.

Improvements. Improvements of using restrictive inheritance-based rule conflict resolution include savings in computing resources and in human development cycles, including:
1) minimal specification by developer. Given an existing base rule set and the need to extend and revise to expand its operating domain, the developer simply needs to specify deltas to this base ruleset with partially-specified derived rules and restrictive inheritance, and does not need to modify existing base rules;
2) rule conflict resolution has application meaning and can be compiler-checked in advance because an overlapping rule is logically overriding a base rule. This also avoids the overhead of conflict resolution during rule evaluation; and/or
3) the compiler may enforce absence of overlap at each inheritance level, allowing for efficient rule execution by automatically generating a decision tree from the rules, given that there is a single action per evaluation.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a sensor;
a physical actuator;
a processor coupled to the sensor and the physical actuator, wherein the processor is configured to:
structure a ruleset to satisfy a restrictive inheritance requirement;
select a rule from a set of matched rules with no successor, wherein the set of matched rules is a subset of the ruleset;
output a rule action associated with this selected rule;
receive input from the sensor; and
control the physical actuator based at least in part on the input from the sensor and the rule action associated with this selected rule.

2. The system of claim 1, wherein selecting the rule from the set of matched rules with no successor is based at least in part on rule evaluation.

3. The system of claim 1, wherein selecting the rule from the set of matched rules with no successor is based at least in part on decision tree generation.

4. The system of claim 3, wherein decision tree generation avoids multi-matches by selecting the most derived rule when two or more rules are applicable to an input.

5. The system of claim 1, wherein restrictive inheritance is realized in part by deriving the ruleset restrictively from a base ruleset that is a restrictive inheritance ruleset.

6. The system of claim 5, wherein one or more derived rules are partially-specified and materialized using partially-specified restrictive inheritance.

7. The system of claim 6, wherein one of the one or more partially-specified derived rules explicitly specifies at least one of its base rules.

8. The system of claim 6, wherein one of the one or more partially-specified derived rules is derived from at least one base rule with which it overlaps.

9. The system of claim 6, wherein the outputted rule action is a combination of rule actions of a base rule and a derived rule, wherein the base rule is a rule from the base ruleset.

10. The system of claim 1, wherein a rule condition is specified as a conjunction of subconditions.

11. The system of claim 10, wherein one or more subconditions are indicated as a range of values.

12. The system of claim 1, wherein the restrictive inheritance requirement comprises that there is a default or first rule that is a predecessor in a partial order to all rules in the ruleset.

13. The system of claim 1, wherein the restrictive inheritance requirement comprises that each successor rule to a given rule in the ruleset matches at most a subset of input scenarios that a rule condition for the given rule matches.

14. The system of claim 1, wherein the restrictive inheritance requirement comprises that there is no overlap between input scenarios matched by a first successor rule to a given rule and a second successor rule to the given rule, wherein two rules overlap if at least one input scenario or set of input values for which conditions of the two rules are true.

15. The system of claim 14, wherein overlap is determined by exhaustively evaluating rule conditions using all possible input values.

16. The system of claim 14, wherein overlap is determined by pre-analyzing rule conditions to evaluate rule conditions using a reduced number of input values.

17. The system of claim 1, wherein selecting the rule from the set of matched rules with no successor is based at least in part on the rule condition of the selected rule and the input from the sensor.

18. The system of claim 1, wherein if a derived ruleset adds additional features or subconditions, then its base rules are interpreted as implicitly specifying “don't care” for these additional features or subconditions.

19. A method, comprising:
structuring a ruleset to satisfy a restrictive inheritance requirement;
selecting a rule from a set of matched rules with no successor, wherein the set of matched rules is a subset of the ruleset;
outputting a rule action associated with this selected rule;
receiving input from a sensor; and
controlling a physical actuator based at least in part on the input from the sensor and the rule action associated with this selected rule.

20. The method of claim 19, wherein restrictive inheritance is realized in part by deriving the ruleset restrictively from a base ruleset that is a restrictive inheritance ruleset.

21. A computer program product embodied in a non-transitory computer readable medium and comprising computer instructions for:
structuring a ruleset to satisfy a restrictive inheritance requirement;
selecting a rule from a set of matched rules with no successor, wherein the set of matched rules is a subset of the ruleset;
outputting a rule action associated with this selected rule;
receiving input from a sensor; and
controlling a physical actuator based at least in part on the input from the sensor and the rule action associated with this selected rule.

22. The computer program product of claim 21, wherein restrictive inheritance is realized in part by deriving the ruleset restrictively from a base ruleset that is a restrictive inheritance ruleset.
